(19) United States
(12) Patent Application Publication
(10) Pub. No.: US 2024/0331335 A1
(43) Pub. Date: Oct. 3, 2024

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventors: Nobuyuki HIRAHARA, Tokyo (JP); Akimichi ICHINOSE, Tokyo (JP)

(73) Assignee: FUJIFILM Corporation, Tokyo (JP)

(21) Appl. No.: 18/587,994

(22) Filed: Feb. 27, 2024

(30) Foreign Application Priority Data
Mar. 27, 2023 (JP) 2023-050620

(51) Int. Cl. G06V 10/25

(52) U.S. Cl. CPC G06V 10/25

(57) ABSTRACT

A processor, derives a likelihood of a region of interest for each pixel of an input image via a first derivation model, and derives a predictive value representing a possibility that a specific finding is included in the input image from the input image and the likelihood of the region of interest via a second derivation model, in which the region of interest is a region serving as a basis for obtaining the predictive value.

### CROSS REFERENCE TO RELATED APPLICATIONS

The present application claims priority from Japanese Patent Application No. 2023-050620, filed on Mar. 27, 2023, the entire disclosure of which is incorporated herein by reference.

### BACKGROUND

### Technical Field

The present disclosure relates to an image processing apparatus, an image processing method, and an image processing program.

### Related Art

In recent years, with the progress of medical devices, such as a computed tomography (CT) apparatus and a magnetic resonance imaging (MRI) apparatus, it is possible to make an image diagnosis by using a medical image having a higher quality and a higher resolution. In addition, computer-aided diagnosis (CAD), in which the presence probability, positional information, and the like of a lesion are derived by analyzing the medical image and presented to a doctor, such as an image interpretation doctor, is put into practical use.

For example, JP2018-175343A proposes a method in which a first discriminator that discriminates a lesion region candidate in a medical image and a second discriminator that discriminates whether the lesion region candidate discriminated by the first discriminator is a blood vessel region or a bronchial region are provided, and a lesion region candidate, which is not discriminated as the blood vessel region or the bronchial region by the second discriminator, is detected as a lesion region.

In some cases, the lesion is not clearly shown on the medical image depending on a type and a size of the lesion or a method of capturing the medical image. For example, a tumor related to pancreatic cancer is relatively clearly shown in a contrast tomographic image of an abdomen, but the tumor related to the pancreatic cancer is hardly shown in a non-contrast tomographic image. In some cases, the doctor finds such a hardly shown lesion by using an indirect finding shown in the medical image as a clue. The indirect finding represents a feature of at least one of a property or a shape of peripheral tissue of the lesion, which appears with the development of the lesion. Examples of the indirect finding include atrophy, swelling, stenosis, and calcification.

Since the CAD in the related art is developed on the premise that the lesion is clearly shown on the medical image to some extent, it is difficult to find the lesion that is hardly shown as described above. For this reason, there is a demand for the development of the CAD based on the above-described thought of the doctor, that is, finding the lesion that is hardly shown by using the indirect finding as a clue.

### SUMMARY OF THE INVENTION

The present disclosure has been made in view of the above circumstances, and is to accurately derive a possibility that a specific finding is included in an input image according to a method based on the thought of a person who views the input image, such as a doctor.

A first aspect of the present disclosure relates to an image processing apparatus comprising: at least one processor, in which the processor derives a likelihood of a region of interest for each pixel of an input image via a first derivation model, and derives a predictive value representing a possibility that a specific finding is included in the input image from the input image and the likelihood of the region of interest via a second derivation model, and the region of interest is a region serving as a basis for obtaining the predictive value.

A second aspect of the present disclosure relates to the image processing apparatus according to the first aspect of the present disclosure, in which the first derivation model may derive, as the likelihood of the region of interest, a degree of certainty that each pixel of the input image is the region of interest.

A third aspect of the present disclosure relates to the image processing apparatus according to the second aspect of the present disclosure, in which the processor may derive intermediate information from the input image and the likelihood of the region of interest, and the second derivation model may derive the predictive value from the intermediate information.

A fourth aspect of the present disclosure relates to the image processing apparatus according to the third aspect of the present disclosure, in which the processor may derive the intermediate information by multiplying the input image and the likelihood of the region of interest.

A fifth aspect of the present disclosure relates to the image processing apparatus according to any one of the second to fourth aspects of the present disclosure, in which the first derivation model and the second derivation model may be constructed by performing machine learning on a neural network, and the machine learning may be machine learning based on a restriction that a sum of the degree of certainty for each pixel of the input image after the neural network is updated by training is equal to or less than a sum of the degree of certainty before the neural network is updated by the training.

A sixth aspect of the present disclosure relates to the image processing apparatus according to any one of the second to fourth aspects of the present disclosure, in which the first derivation model and the second derivation model may be constructed by performing machine learning on a neural network, and the machine learning may be machine learning based on a restriction that the number of pixels of the input image after the neural network is updated by training, in which the degree of certainty is equal to or more than a predetermined threshold value, is equal to or less than the number of pixels of the input image before the neural network is updated by the training, in which the degree of certainty is equal to or more than the predetermined threshold value.

A seventh aspect of the present disclosure relates to the image processing apparatus according to any one of the first to sixth aspects of the present disclosure, in which the processor may derive a region of a finding indirectly estimated from the specific finding in the input image based on the input image and the predictive value.

The present disclosure relates to an image processing method comprising: deriving a likelihood of a region of interest for each pixel of an input image via a first derivation model; and deriving a predictive value representing a possibility that a specific finding is included in the input image from the input image and the likelihood of the region of interest via a second derivation model, in which the region of interest is a region serving as a basis for obtaining the predictive value.

The present disclosure relates to an image processing program causing a computer to execute: a procedure of deriving a likelihood of a region of interest for each pixel of an input image via a first derivation model; and a procedure of deriving a predictive value representing a possibility that a specific finding is included in the input image from the input image and the likelihood of the region of interest via a second derivation model, in which the region of interest is a region serving as a basis for obtaining the predictive value.

According to the aspects of the present disclosure, it is possible to accurately derive the possibility that the specific finding is included in the input image.

### BRIEF DESCRIPTION OF THE DRAWINGS

FIG. 1 is a diagram showing a schematic configuration of a diagnosis support system to which an image processing apparatus according to an embodiment of the present disclosure is applied.

FIG. 2 is a diagram showing a hardware configuration of the image processing apparatus according to the present embodiment.

FIG. 3 is a functional configuration diagram of the image processing apparatus according to the present embodiment.

FIG. 4 is a diagram schematically showing processing performed by a derivation unit.

FIG. 5 is a diagram showing a pancreatic duct region in a medical image.

FIG. 6 is a diagram schematically showing processing performed by a discrimination unit.

FIG. 7 is a diagram schematically showing another processing performed by the derivation unit.

FIG. 8 is a diagram showing teacher data used for training of a first derivation model.

FIG. 9 is a diagram for describing the training of the first derivation model.

FIG. 10 is a diagram showing teacher data used for training of a discriminative model.

FIG. 11 is a diagram for describing the training of the discriminative model.

FIG. 12 is a diagram showing a display screen of an extraction result of a lesion.

FIG. 13 is a flowchart showing processing performed in the present embodiment.

### DETAILED DESCRIPTION

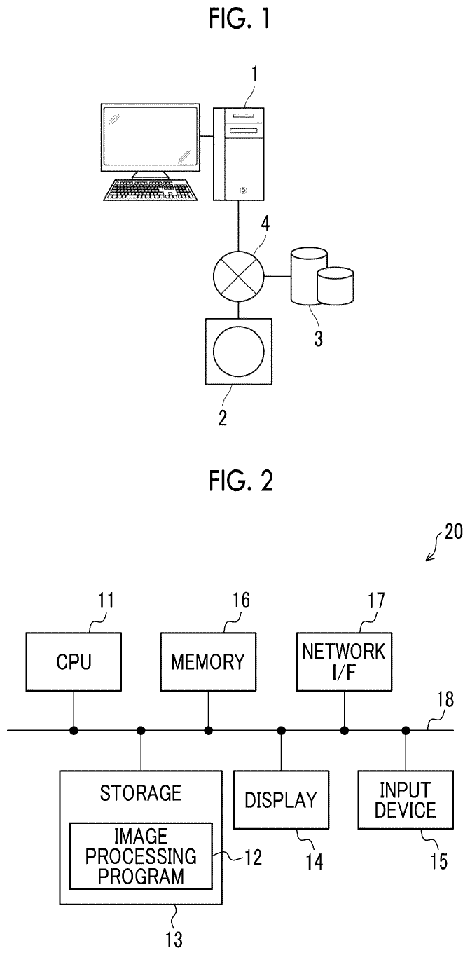

Hereinafter, an embodiment of the present disclosure will be described with reference to the drawings. First, a configuration of a medical information system to which an image processing apparatus according to the present embodiment is applied will be described. FIG. 1 is a diagram showing a schematic configuration of the medical information system. In the medical information system shown in FIG. 1, a computer 1 including the image processing apparatus according to the present embodiment, an imaging apparatus 2, and an image storage server 3 are connected via a network 4 in a communicable state.

The computer 1 includes the image processing apparatus according to the present embodiment, and an image processing program according to the present embodiment is installed in the computer 1. The computer 1 may be a workstation or a personal computer directly operated by a doctor who makes a diagnosis, or may be a server computer connected to the workstation or the personal computer via the network. The image processing program is stored in a storage device of the server computer connected to the network or in a network storage to be accessible from the outside, and is downloaded and installed in the computer 1 used by the doctor, in response to a request. Alternatively, the image processing program is distributed in a state of being recorded on a recording medium, such as a digital versatile disc (DVD) or a compact disc read only memory (CD-ROM), and is installed in the computer 1 from the recording medium.

The imaging apparatus 2 is an apparatus that images a diagnosis target part of a subject to generate a three-dimensional image showing the part and is, specifically, a CT apparatus, an MRI apparatus, a positron emission tomography (PET) apparatus, and the like. The three-dimensional image including a plurality of tomographic images generated by the imaging apparatus 2 is transmitted to and stored in the image storage server 3. It should be noted that, in the present embodiment, the imaging apparatus 2 is a CT apparatus, and a CT image of an abdomen of the subject is generated as the three-dimensional image. It should be noted that the acquired CT image may be a contrast CT image or a non-contrast CT image.

The image storage server 3 is a computer that stores and manages various data, and comprises a large-capacity external storage device and database management software. The image storage server 3 communicates with another device via the wired or wireless network 4, and transmits and receives image data and the like to and from the other device. Specifically, the image storage server 3 acquires various data including the image data of the CT image generated by the imaging apparatus 2 via the network, and stores and manages the various data in the recording medium, such as the large-capacity external storage device. It should be noted that the storage format of the image data and the communication between the devices via the network 4 are based on a protocol, such as digital imaging and communication in medicine (DICOM).

Next, the image processing apparatus according to the present embodiment will be described. FIG. 2 is a diagram showing a hardware configuration of the image processing apparatus according to the present embodiment. As shown in FIG. 2, the image processing apparatus 20 includes a central processing unit (CPU) 11, a non-volatile storage 13, and a memory 16 as a transitory storage region. Moreover, the image processing apparatus 20 includes a display 14, such as a liquid crystal display, an input device 15, such as a keyboard and a mouse, and a network interface (I/F) 17 connected to the network 4. The CPU 11, the storage 13, the display 14, the input device 15, the memory 16, and the network I/F 17 are connected to a bus 18. It should be noted that the CPU 11 is an example of a processor according to the present disclosure.

The storage 13 is realized by a hard disk drive (HDD), a solid state drive (SSD), a flash memory, and the like. An image processing program 12 is stored in the storage 13 as a storage medium. The CPU 11 reads out the image processing program 12 from the storage 13, develops the image processing program 12 in the memory 16, and executes the developed image processing program 12.

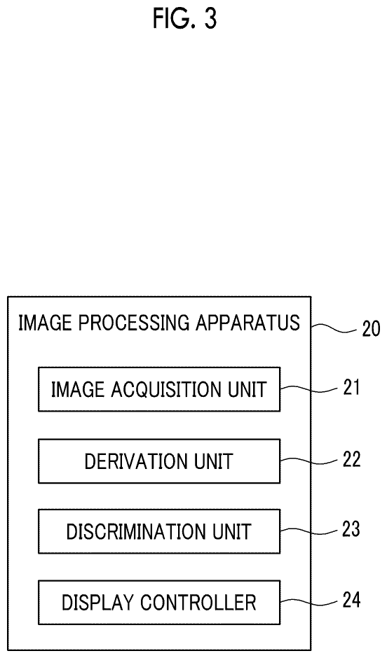

Hereinafter, a functional configuration of the image processing apparatus according to the present embodiment will be described. FIG. 3 is a diagram showing the functional configuration of the image processing apparatus according to the present embodiment. As shown in FIG. 3, the image processing apparatus 20 comprises an image acquisition unit 21, a derivation unit 22, a discrimination unit 23, and a display controller 24. By executing the image processing program 12 by the CPU 11, the CPU 11 functions as the image acquisition unit 21, the derivation unit 22, the discrimination unit 23, and the display controller 24.

The image acquisition unit 21 acquires a medical image G0 that is a processing target from the image storage server 3 in response to an instruction from the input device 15 by an operator. In the present embodiment, the medical image G0 is the CT image including the plurality of tomographic images including the abdomen of the human body. The medical image G0 is an example of an input image according to the present disclosure.

The derivation unit 22 derives a likelihood of a region of interest for each pixel of the medical image G0, and derives a predictive value representing a possibility that a specific finding is included in the medical image G0 from the medical image G0 and the likelihood of the region of interest. The region of interest is a region serving as a basis for obtaining the predictive value. In the present embodiment, the likelihood of the region of interest is a degree of certainty that each pixel of the medical image G0 is the region of interest. The degree of certainty may be derived so that, in the medical image G0, a pixel value of the region of interest is 1 and a pixel value of a region other than the region of interest is 0, and may be derived so that each pixel of the medical image G0 has a value equal to or more than 0 and equal to or less than 1. In the latter case, as the degree of certainty for the pixel included in the region of interest is closer to 1, such a pixel further represents the region serving as the basis for obtaining the predictive value. In the present embodiment, the degree of certainty has a value equal to or more than 0 and equal to or less than 1. It should be noted that, in the present embodiment, the specific finding is an indirect finding that is a basis for determining the presence or absence of the lesion.

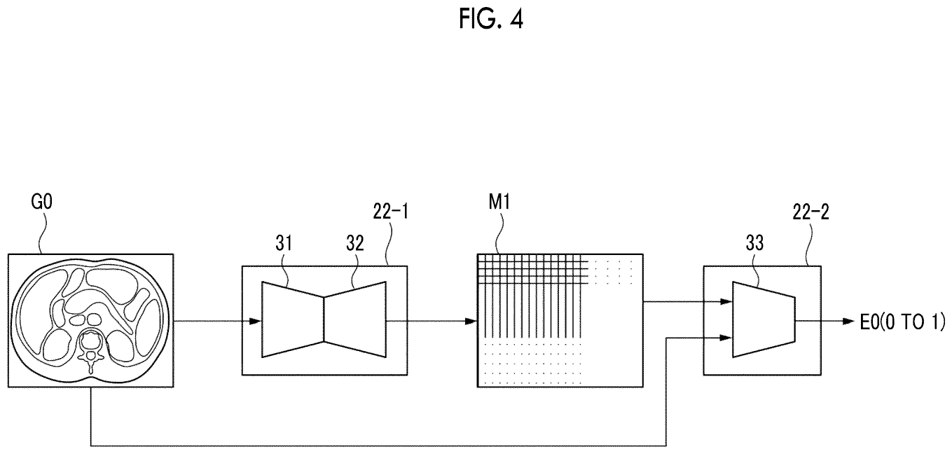

FIG. 4 is a diagram schematically showing processing performed by the derivation unit 22. In the present embodiment, the derivation unit 22 includes a first derivation model 22-1 and a second derivation model 22-2 which are subjected to machine learning. In the present embodiment, the discrimination unit 23 described below extracts a lesion region of a pancreas, such as a cancer, from the medical image G0. Therefore, the second derivation model 22-2 derives a predictive value representing a possibility that pancreatic duct stenosis, which is the indirect finding of the lesion of the pancreas, is included in the medical image G0. On the other hand, the first derivation model 22-1 derives, as the likelihood of the region of interest, a likelihood of the pancreatic duct region that is the region serving as the basis of the pancreatic duct stenosis for each pixel of the medical image G0.

The first derivation model 22-1 includes an encoder 31 and a decoder 32, derives, as the likelihood of the region of interest, the degree of certainty of the pancreatic duct region that is the basis for obtaining the predictive value representing the possibility that the pancreatic duct stenosis is included, and derives a degree-of-certainty map M1 in which the pixel value of each pixel is the degree of certainty.

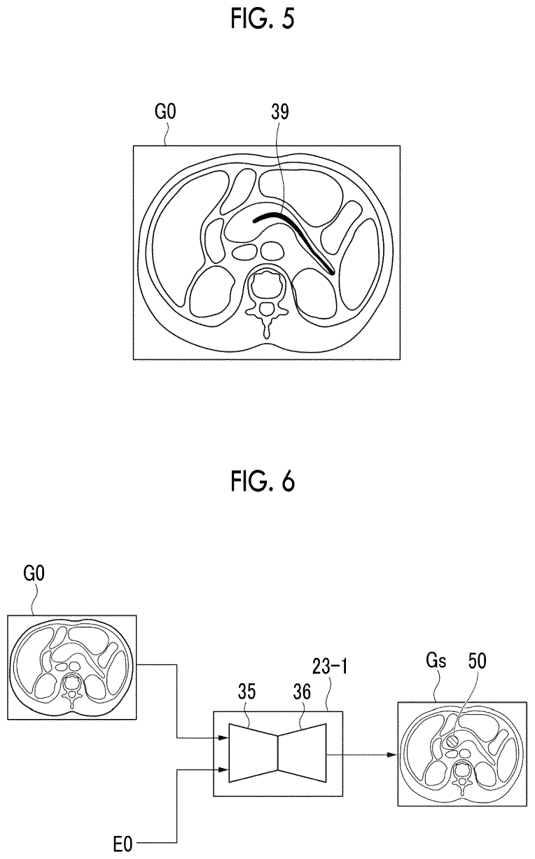

Since each pixel of the degree-of-certainty map M1 is the degree of certainty that each pixel is the region of interest, each pixel has a value equal to or more than 0 and equal to or less than 1. Therefore, as shown in FIG. 5, the value of each pixel of the degree-of-certainty map M1 is closer to 1 in a pancreatic duct region 39 in the medical image G0.

The second derivation model 22-2 includes an encoder 33, and derives a predictive value E0 representing the possibility that the pancreatic duct stenosis is included in the medical image G0, based on the medical image G0 and the degree-of-certainty map M1 derived by the first derivation model 22-1. It should be noted that the predictive value E0 has a value equal to or more than 0 and equal to or less than 1, and the possibility that the pancreatic duct stenosis is included in the medical image G0 is higher as the predictive value E0 is closer to 1.

The discrimination unit 23 extracts the lesion region of the pancreas included in the medical image G0 based on the medical image G0 and the predictive value E0 derived by the derivation unit 22. FIG. 6 is a diagram schematically showing processing performed by the discrimination unit 23. As shown in FIG. 6, the discrimination unit 23 includes a discriminative model 23-1 subjected to machine learning. As shown in FIG. 6, the medical image G0 and the predictive value E0 are input to the discriminative model 23-1, and the lesion region of the pancreas in the medical image G0 is extracted. In FIG. 6, the extraction of the lesion region via the discriminative model 23-1 is shown by an output image Gs in which a mask 50 is assigned to the lesion region in the pancreas in the medical image G0. In the present embodiment, the discrimination unit 23 extracts the lesion region of the pancreas, but the present disclosure is not limited to this. The discrimination unit 23 may discriminate at least one of a probability that the lesion is a specific disease (for example, cancer), the presence or absence of the lesion, or a malignancy degree of the lesion.

Here, in a case in which the doctor interprets the medical image G0 to specify the lesion of the pancreas, the indirect finding representing a change in the property and the shape of a peripheral tissue of the lesion, such as pancreatic duct stenosis, is used as a clue. It should be noted that the “indirect” of the indirect finding is an expression in a sense that contrasts with a case in which the lesion, such as a tumor, is expressed as a “direct” finding that is directly connected to the disease, such as the cancer. Also, in order to specify the pancreatic duct stenosis, the pancreatic duct region in the pancreas is used as a clue. Here, the pancreatic duct region is a region serving as a basis for specifying the pancreatic duct stenosis. Therefore, the degree of certainty derived by the first derivation model 22-1 represents the certainty that each pixel of the medical image G0 is the region serving as the basis for specifying the pancreatic duct stenosis.

Hereinafter, the first derivation model 22-1, the second derivation model 22-2, and the discriminative model 23-1 will be described.

The first derivation model 22-1 is constructed by a neural network subjected to machine learning to derive the degree of certainty representing the likelihood of the pancreatic duct region for each pixel of the medical image G0. For example, the first derivation model 22-1 is constructed by a convolutional neural network (CNN), such as residual networks (ResNet) or U-shaped networks (U-Net). In the present embodiment, the first derivation model 22-1 is a U-Net including the encoder 31 and the decoder 32 as described above.

In a case in which the medical image G0 is input, the encoder 31 outputs a latent expression in which a feature of the medical image G0 for deriving the degree of certainty representing the likelihood of the pancreatic duct region is dimensionally compressed. The first derivation model 22-1 derives the degree of certainty representing the likelihood of the pancreatic duct region. Therefore, the latent expression includes a feature for the pancreatic duct region.

The decoder 32 reconstructs the latent expression to output the degree of certainty representing the likelihood of the pancreatic duct region for each pixel of the medical image G0. Since the degree of certainty is derived for each pixel of the medical image G0, the degree-of-certainty map M1 in which each pixel represents the degree of certainty is derived by the decoder 32.

The second derivation model 22-2 is a neural network subjected to machine learning to derive the predictive value E0 representing the possibility that the pancreatic duct stenosis is included in the medical image G0 from the medical image G0 and the degree-of-certainty map M1. The second derivation model 22-2 is a convolutional neural network including only the encoder 33, but the present disclosure is not limited to this.

In a case in which the medical image G0 and the degree-of-certainty map M1 are input, the encoder 33 outputs the predictive value E0 representing the possibility that the pancreatic duct stenosis is included in the medical image G0.

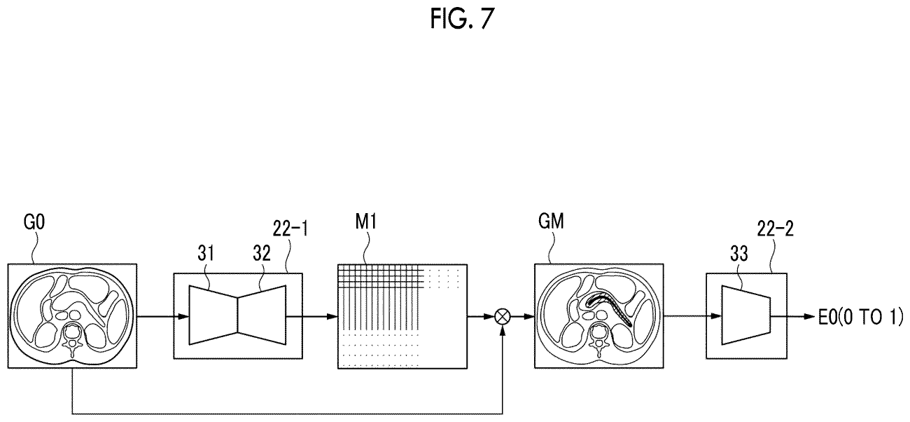

It should be noted that, as shown in FIG. 7, the derivation unit 22 may derive intermediate information GM from the medical image G0 and the degree-of-certainty map M1, and the second derivation model 22-2 may derive the predictive value E0 from the intermediate information GM. The intermediate information GM is obtained by multiplying the pixel values of the corresponding pixels between the medical image G0 and the degree-of-certainty map M1. Here, since the pixel value of each pixel of the degree-of-certainty map M1 has a value equal to or more than 0 and equal to or less than 1, the intermediate information GM is information obtained by multiplying the pixel value of each pixel of the medical image G0 by a value equal to or more than 0 and equal to or less than 1.

The discriminative model 23-1 is a neural network subjected to machine learning to extract the lesion region of the pancreas in the medical image G0 based on the medical image G0 and the predictive value E0.

The discriminative model 23-1 includes an encoder 35 and a decoder 36. In a case in which the medical image G0 and the predictive value E0 are input, the encoder 35 outputs the latent expression in which the feature of the medical image G0 for extracting the lesion region of the pancreas is dimensionally compressed. The discriminative model 23-1 extracts a lesion region F1 of the pancreas. Therefore, the latent expression includes a feature for a region serving as a basis for extracting the lesion region of the pancreas.

The decoder 36 extracts the lesion region of the pancreas in the medical image G0 by reconstructing the latent expression, and outputs the output image Gs in which the mask is assigned to the lesion region of the pancreas.

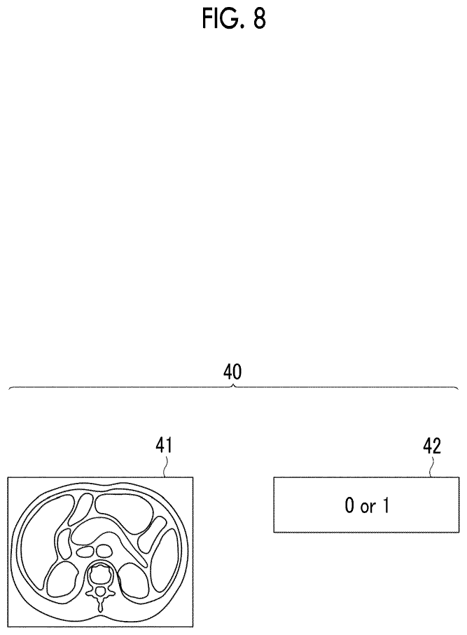

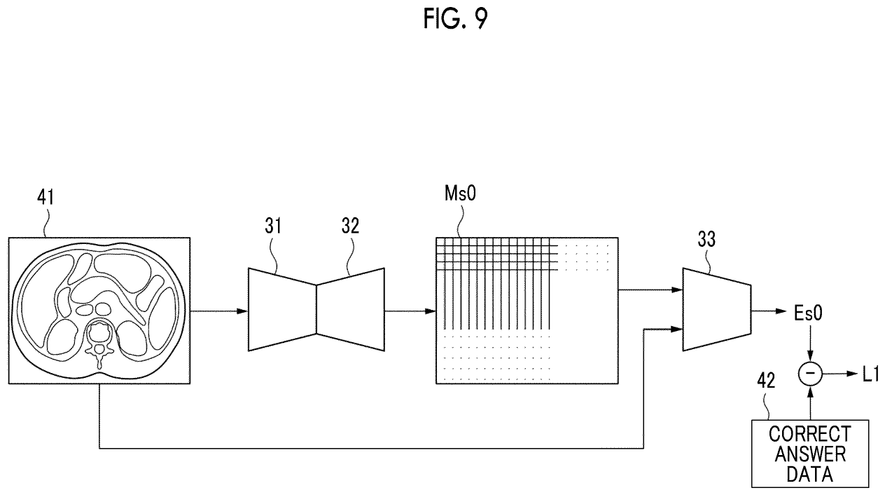

Hereinafter, training of the first derivation model 22-1, the second derivation model 22-2, and the discriminative model 23-1 will be described. In the present embodiment, the first derivation model 22-1 and the second derivation model 22-2 are simultaneously trained. FIG. 8 is a diagram showing teacher data used for training of the first derivation model 22-1 and the second derivation model 22-2, and FIG. 9 is a diagram for describing the training of the first derivation model 22-1 and the second derivation model 22-2. As shown in FIG. 8, teacher data 40 includes a medical image for training 41 and correct answer data 42. The medical image for training 41 is the medical image including the pancreas. The correct answer data 42 is a value of 0 or 1, which represents the presence or absence of the pancreatic duct stenosis in the medical image for training 41. That is, the correct answer data 42 is 1 in a case in which the pancreatic duct stenosis is included in the medical image for training 41, and the correct answer data 42 is 0 in a case in which the pancreatic duct stenosis is not included in the medical image for training 41.

In the training, as shown in FIG. 9, first, the medical image for training 41 is input to the encoder 31, and the degree of certainty representing the likelihood of the pancreatic duct region for each pixel of the medical image for training 41 is output from the decoder 32. FIG. 9 shows that a degree-of-certainty map for training Ms0 is output from the decoder 32.

Next, as shown in FIG. 9, the medical image for training 41 and the degree-of-certainty map for training Ms0 are input to the encoder 33, and a predictive value for training Es0 representing the possibility that the pancreatic duct stenosis is included in the medical image for training 41 is output. The predictive value Es0 has a value equal to or more than 0 and equal to or less than 1. Then, a difference between the predictive value Es0 and the correct answer data 42 is derived as a loss L1.

It should be noted that, in a case in which the encoder 33 is trained to derive the predictive value E0 based on the intermediate information GM, intermediate information for training is derived from the medical image for training 41 and the degree-of-certainty map for training Ms0, and the intermediate information for training is input to the encoder 33.

The encoder 31 and the decoder 32, and the encoder 33 are trained so that the loss L1 is reduced. Accordingly, a parameter such as a weight of the connection in the encoder 31, the decoder 32, and the encoder 33 is updated. In this case, a restriction is applied that a sum of the degree of certainty for each pixel of the medical image for training 41 after the neural network is updated by the training is equal to or less than a sum of the degree of certainty before the neural network is updated by the training.

That is, in a case in which the medical image for training 41 is input, a sum S1 of the degree of certainty for each pixel of the medical image for training 41 output from the decoder 32 is calculated, and the parameter in the encoder 31, the decoder 32, and the encoder 33 is updated so that the loss L1 is reduced. In this case, the parameter is updated so that the predictive value Es0 approaches 0 in a case in which the correct answer data 42 is 0, and the predictive value Es0 approaches 1 in a case in which the correct answer data 42 is 1. In this case, a restriction is applied that a sum S2 of the degree of certainty for each pixel of the medical image for training 41 output from the decoder 32 after the parameter is updated is equal to or less than the sum S1 of the degree of certainty for each pixel of the medical image for training 41 output from the decoder 32 before the parameter is updated, and the parameter is updated.

It should be noted that a restriction may be applied that the number of pixels in which the degree of certainty for each pixel of the medical image for training 41 after the neural network is updated by the training is equal to or more than a predetermined threshold value is equal to or less than the number of pixels in which the degree of certainty f before the neural network is updated by the training is equal to or more than the predetermined threshold value. In this case, a restriction is applied that a sum S4 of the pixels in which the degree of certainty for each pixel of the medical image for training 41 output from the decoder 32 after the parameter is updated is equal to or more than the predetermined threshold value is equal to or less than a sum S3 of the pixels in which the degree of certainty for each pixel of the medical image for training 41 output from the decoder 32 before the parameter is updated is equal to or more than the predetermined threshold value, and the parameter is updated.

As a result, the encoder 31 and the decoder 32 are trained so that the degree of certainty is increased in the pixels in a range narrowed down by the pancreatic duct region in the medical image for training 41. In addition, the encoder 33 is trained to output the predictive value representing the possibility that the pancreatic duct stenosis is included, based on the degree of certainty in a narrower range in the medical image for training 41. The first derivation model 22-1 and the second derivation model 22-2 are constructed by repeating the training until the loss L1 is equal to or less than a predetermined threshold value using a plurality of teacher data, or by repeating the training a predetermined number of times.

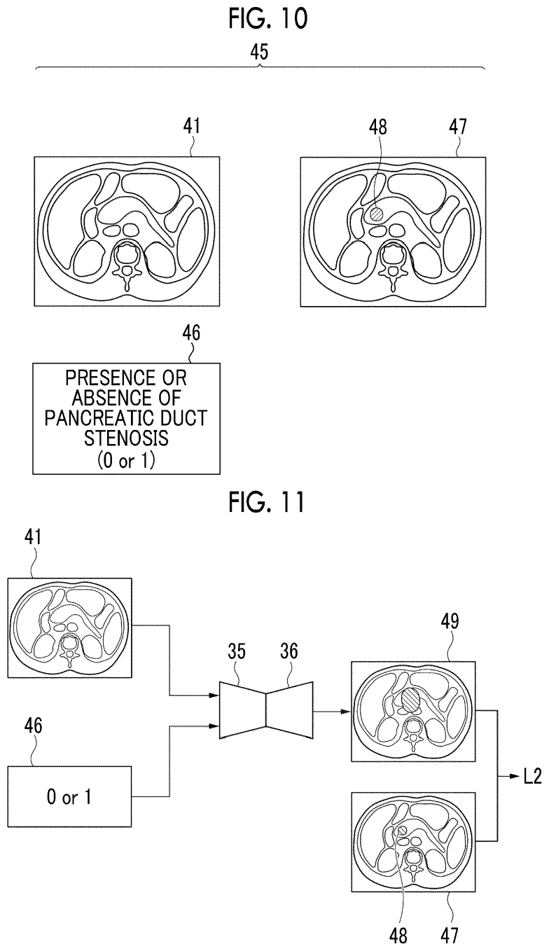

FIG. 10 is a diagram showing teacher data used for training of the discriminative model 23-1, and FIG. 11 is a diagram for describing the training of the discriminative model 23-1. As shown in FIG. 10, teacher data 48 includes the medical image for training 41, information 46 representing the presence or absence of the pancreatic duct stenosis, and correct answer data 47. The medical image for training 41 is the medical image including the pancreas similar to the correct answer data 42 for training the first derivation model 22-1 and the second derivation model 22-2. The information 46 representing the presence or absence of the pancreatic duct stenosis is a value of 0 or 1, which represents whether or not the pancreatic duct stenosis is included in the medical image for training 41. That is, the information 46 representing the presence or absence of the pancreatic duct stenosis is 0 in a case in which the pancreatic duct stenosis is not included in the medical image for training 41, and is 1 in a case in which the pancreatic duct stenosis is included. The correct answer data 47 is a mask image in which a mask 48 is assigned to the lesion region of the pancreas in the medical image for training 41.

In the training, as shown in FIG. 11, the medical image for training 41 and the information 46 are input to the encoder 35, the lesion region of the pancreas in the medical image for training 41 is extracted by the decoder 36, and an output image 49 in which the lesion region is masked is derived. A difference between the output image 49 and the correct answer data 47 is derived as a loss L2.

The encoder 35 and the decoder 36 are trained so that the loss L2 is reduced. That is, the parameter such as the weight of the connection in the encoder 35 and the decoder 36 is updated. Accordingly, the encoder 35 and the decoder 36 are trained to extract the lesion region of the pancreas from the input image. The discriminative model 23-1 is constructed by repeating the training until the loss L2 is equal to or less than a predetermined threshold value using a plurality of teacher data, or by repeating the training a predetermined number of times.

It should be noted that the training of the first derivation model 22-1, the second derivation model 22-2, and the discriminative model 23-1 is not limited to the training using the teacher data. The first derivation model 22-1, the second derivation model 22-2, and the discriminative model 23-1 may be constructed by training the neural network without using the teacher data.

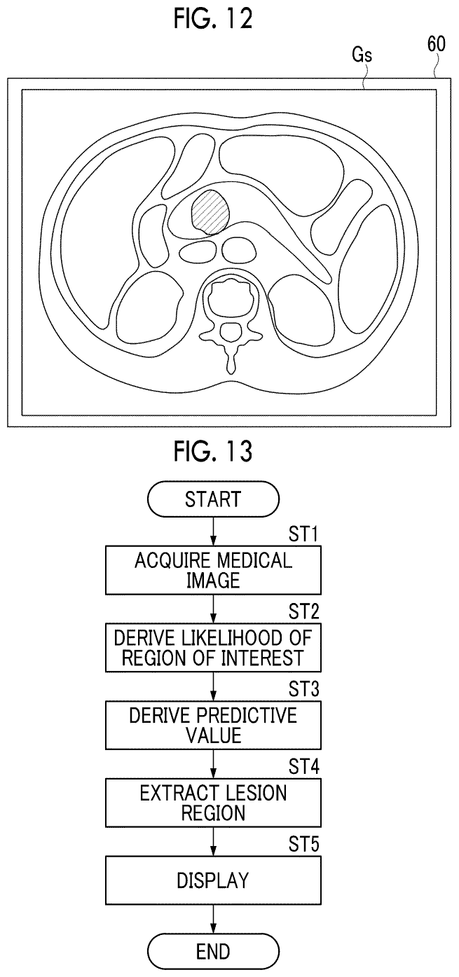

The display controller 24 displays the output image in which the lesion region extracted by the discrimination unit 23 is masked, on the display 14. FIG. 12 is a diagram showing a display screen of the output image. As shown in FIG. 12, a display screen 60 displays the output image Gs in which the lesion region extracted by the discrimination unit 23 is masked, as represented by hatching.

Hereinafter, processing performed in the present embodiment will be described. FIG. 13 is a flowchart showing the processing performed in the present embodiment. First, the image acquisition unit 21 acquires the medical image G0 from the storage 13 (step ST1), and the first derivation model 22-1 of the derivation unit 22 derives the likelihood of the region of interest for each pixel of the medical image G0 (step ST2). Further, the second derivation model 22-2 of the derivation unit 22 derives the predictive value E0 representing the possibility that the specific finding is included in the medical image G0 from the medical image G0 and the likelihood of the region of interest (step ST3). Then, the discrimination unit 23 extracts the lesion region of the pancreas included in the medical image G0 from the medical image G0 and the predictive value E0 (step ST4). Then, the display controller 24 displays the output image Gs in which the lesion region is masked, on the display 14 (step ST5), and terminates the processing.

As described above, in the present embodiment, the likelihood of the region of interest for each pixel of the medical image G0 is derived by the first derivation model 22-1, and the predictive value representing the possibility that the specific finding is included in the medical image G0 is derived from the medical image G0 and the likelihood of the region of interest by the second derivation model 22-2. Here, the region of interest is the region serving as the basis for obtaining the predictive value E0. Therefore, the likelihood of the region of interest is derived to more represent the region of interest as the likelihood of the region of interest is more used as the basis of the presence or absence of the specific finding used as a clue by the doctor in specifying the lesion in the medical image G0. Therefore, according to the present embodiment, it is possible to accurately derive the possibility that the specific finding is included in the input image, that is, the medical image G0, according to a method based on the thought of a person who views the input image, such as the doctor.

It should be noted that, in the embodiment described above, the first derivation model 22-1 derives the likelihood of the pancreatic duct region as the likelihood of the region of interest, and the second derivation model 22-2 derives the predictive value E0 representing the possibility that the pancreatic duct stenosis is included in the medical image G0, but the present disclosure is not limited to this. For example, the first derivation model 22-1 may divide the pancreas into a head portion, a body portion, and a caudal portion to derive the likelihood of the region of each of the head portion, the body portion, and the caudal portion as the likelihood of the region of interest, and the second derivation model 22-2 may derive a predictive value representing a possibility that a portion with a change in the property or the shape out of the head portion, the body portion, and the caudal portion is included in the medical image G0.

In the embodiment described above, the region of interest is the region in the same pancreas, but may be a region in a structure other than the pancreas. For example, the region in the structure other than the pancreas, such as a viscera and a blood vessel adjacent to the pancreas, may be derived as the region of interest.

In the embodiment described above, the medical image G0 may be displayed on the display 14 by emphasizing a region in which the likelihood of the region of interest derived by the first derivation model 22-1 is large. For example, an image in which each pixel has a color corresponding to the degree of certainty in the degree-of-certainty map M1 shown in FIG. 4 may be displayed on the display 14.

In addition, in the embodiment described above, the target organ is the pancreas, but the present disclosure is not limited to this. In addition to the pancreas, any organ, such as the brain, the heart, the lung, and the liver, can be used as the target organ.

In addition, in the embodiment described above, the CT image is used as the medical image G0, but the present disclosure is not limited to this. In addition to the CT image, other three-dimensional image, such as the MRI image, or any image, such as a radiation image acquired by simple imaging, can be used as the medical image G0.

In addition, in the embodiment described above, various processors shown below can be used as the hardware structure of the processing units that execute various types of processing, such as the image acquisition unit 21, the derivation unit 22, the discrimination unit 23, and the display controller 24. As described above, the various processors include, in addition to the CPU that is a general-purpose processor which executes software (program) to function as various processing units, a programmable logic device (PLD) that is a processor of which a circuit configuration can be changed after manufacture, such as a field programmable gate array (FPGA), and a dedicated electrical circuit that is a processor having a circuit configuration which is designed for exclusive use to execute a specific processing, such as an application specific integrated circuit (ASIC).

One processing unit may be configured by one of these various processors or may be configured by a combination of two or more processors of the same type or different types (for example, a combination of a plurality of FPGAs or a combination of the CPU and the FPGA). In addition, a plurality of the processing units may be configured by one processor.

As an example of configuring the plurality of processing units by one processor, first, as represented by a computer of a client, a server, and the like there is an aspect in which one processor is configured by a combination of one or more CPUs and software and this processor functions as a plurality of processing units. Second, as represented by a system on chip (SoC) or the like, there is an aspect of using a processor that realizes the function of the entire system including the plurality of processing units by one integrated circuit (IC) chip. In this way, as the hardware structure, the various processing units are configured by using one or more of the various processors described above.

Further, as the hardware structures of these various processors, more specifically, it is possible to use an electrical circuit (circuitry) in which circuit elements, such as semiconductor elements, are combined.

What is claimed is:

1. An image processing apparatus comprising:
at least one processor,
wherein the processor
derives a likelihood of a region of interest for each pixel of an input image via a first derivation model, and
derives a predictive value representing a possibility that a specific finding is included in the input image from the input image and the likelihood of the region of interest via a second derivation model, and
the region of interest is a region serving as a basis for obtaining the predictive value.

2. The image processing apparatus according to claim 1,
wherein the first derivation model derives, as the likelihood of the region of interest, a degree of certainty that each pixel of the input image is the region of interest.

3. The image processing apparatus according to claim 2,
wherein the processor derives intermediate information from the input image and the likelihood of the region of interest, and
the second derivation model derives the predictive value from the intermediate information.

4. The image processing apparatus according to claim 3,
wherein the processor derives the intermediate information by multiplying the input image and the likelihood of the region of interest.

5. The image processing apparatus according to claim 2,
wherein the first derivation model and the second derivation model are constructed by performing machine learning on a neural network, and
the machine learning is machine learning based on a restriction that a sum of the degree of certainty for each pixel of the input image after the neural network is updated by training is equal to or less than a sum of the degree of certainty before the neural network is updated by the training.

6. The image processing apparatus according to claim 3,
wherein the first derivation model and the second derivation model are constructed by performing machine learning on a neural network, and
the machine learning is machine learning based on a restriction that a sum of the degree of certainty for each pixel of the input image after the neural network is updated by training is equal to or less than a sum of the degree of certainty before the neural network is updated by the training.

7. The image processing apparatus according to claim 4,
wherein the first derivation model and the second derivation model are constructed by performing machine learning on a neural network, and
the machine learning is machine learning based on a restriction that a sum of the degree of certainty for each pixel of the input image after the neural network is updated by training is equal to or less than a sum of the degree of certainty before the neural network is updated by the training.

8. The image processing apparatus according to claim 2,
wherein the first derivation model and the second derivation model are constructed by performing machine learning on a neural network, and
the machine learning is machine learning based on a restriction that the number of pixels of the input image after the neural network is updated by training, in which the degree of certainty is equal to or more than a predetermined threshold value, is equal to or less than the number of pixels of the input image before the neural network is updated by the training, in which the degree of certainty is equal to or more than the predetermined threshold value.

9. The image processing apparatus according to claim 3,
wherein the first derivation model and the second derivation model are constructed by performing machine learning on a neural network, and
the machine learning is machine learning based on a restriction that the number of pixels of the input image after the neural network is updated by training, in which the degree of certainty is equal to or more than a predetermined threshold value, is equal to or less than the number of pixels of the input image before the neural network is updated by the training, in which the degree of certainty is equal to or more than the predetermined threshold value.

10. The image processing apparatus according to claim 4,
wherein the first derivation model and the second derivation model are constructed by performing machine learning on a neural network, and
the machine learning is machine learning based on a restriction that the number of pixels of the input image after the neural network is updated by training, in which the degree of certainty is equal to or more than a predetermined threshold value, is equal to or less than the number of pixels of the input image before the neural network is updated by the training, in which the degree of certainty is equal to or more than the predetermined threshold value.

11. The image processing apparatus according to claim 1,
wherein the processor derives a region of a finding indirectly estimated from the specific finding in the input image based on the input image and the predictive value.

12. An image processing method comprising:
deriving a likelihood of a region of interest for each pixel of an input image via a first derivation model; and
deriving a predictive value representing a possibility that a specific finding is included in the input image from the input image and the likelihood of the region of interest via a second derivation model,
wherein the region of interest is a region serving as a basis for obtaining the predictive value.

13. A non-transitory computer-readable storage medium that stores an image processing program causing a computer to execute:
a procedure of deriving a likelihood of a region of interest for each pixel of an input image via a first derivation model; and
a procedure of deriving a predictive value representing a possibility that a specific finding is included in the input image from the input image and the likelihood of the region of interest via a second derivation model,
wherein the region of interest is a region serving as a basis for obtaining the predictive value.
